(19) United States
(12) Patent Application Publication
(10) Pub. No.: US 2025/0168908 A1
(43) Pub. Date: May 22, 2025

(54) Quality of Service (QoS) Configuration and Management for UE-to-UE (U2U) Relay based Communication

(71) Applicant: Telefonaktiebolaget LM Ericsson (publ), Stockholm (SE)

(72) Inventors: Zhang Zhang, Beijing (CN); Nithin Srinivasan, Köln (DE)

(21) Appl. No.: 18/840,528

(22) PCT Filed: Feb. 2, 2023
(86) PCT No.: PCT/SE2023/050085

§ 371 Date: Aug. 22, 2024

(30) Foreign Application Priority Data
Mar. 4, 2022 (WO) PCT/CN2022/079208

(51) Int. Cl. H04W 76/14; H04W 28/02; H04W 88/04

(52) U.S. Cl. CPC H04W 76/14; H04W 28/0268; H04W 88/04

(57) ABSTRACT

The present disclosure is related to UEs, a network node, and methods performed by the UEs and the network node for QoS configuration and management for U2U relay based communication. A method at a first UE for communicating with a second UE via a first relay UE comprises: negotiating, with the first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

### CROSS-REFERENCE TO RELATED APPLICATION(S)

This application claims priority to the PCT International Application No. PCT/CN 2022/079208, entitled “QUALITY OF SERVICE (QOS) CONFIGURATION AND MANAGEMENT FOR UE-TO-UE (U2U) RELAY BASED COMMUNICATION”, filed on Mar. 4, 2022, which is incorporated herein by reference in its entirety.

### TECHNICAL FIELD

The present disclosure is related to the field of telecommunications, and in particular, to user equipments (UEs), a network node, and methods performed by the UEs and the network node for quality of service (QoS) configuration and management for UE-to-UE (U2U) relay based communication.

### BACKGROUND

Networks have always been hierarchical in nature. Devices have connected to and communicated with one or more base stations ever since the birth of cellular communications. However, new technology enablers in 5G New Radio (NR) will allow devices to connect directly to one another using a technique called sidelink communications. Sidelink is the new communication paradigm in which cellular devices are able to communicate without relaying their data via the network. That means vehicles, robots, and even consumer gadgets could create their own ad hoc networks without using the radio access network as an intermediary.

In the past decade new types of cellular services that go beyond traditional mobile broadband have had a strong impact on the scoping and development of the 5G New Radio (NR) standard. These new cellular services were motivated by the business and economic needs of making the 3GPP ecosystem capable of supporting industrial requirements ranging from direct automotive communication between vehicles to industrial automation with Ultra-Reliable Low-Latency Communication (URLLC) for mission-and business-critical applications. But these same technologies can also be used for consumers to enhance their communication experience. For instance, sidelink proximity services would allow devices to discover and communicate with one another at extremely high data rates and low latency, making them ideal for peer-to-peer gaming and streaming services as well as enhanced Augmented Reality (AR), Virtual Reality (VR) and other wearable device communications.

In contrast with uplink and downlink between a UE and a base station, where resource allocation and link adaptation are controlled by the network, in sidelink the device performs both functions autonomously. In other words, the device gains more control of how to use network resources. At the same time, it is expected that 3GPP upcoming Release will introduce support for sidelink-based relaying and that in future releases multi-link relay will also be considered. Sidelink is also a candidate for future releases as an Industrial Internet of Things (IoT) enabler. By restricting the communication link to one hop, latency is greatly reduced, which is key to mission-critical industrial applications. Furthermore, sidelink is a potential solution for public safety ensuring direct communication or relayed communication between devices.

Another potential use case is multi-hop relaying where multiple sidelink connections are used to leap from/to device to achieve less power consumption, overcome link budget constraints, and enhance latency and reliability. Gaming and entertainment services with AR/VR can also take advantage of sidelink, as will body networks, using direct 5G connections to replace the Bluetooth and eventually Wi-Fi links that currently connect these devices. The result could be a revolutionary change in the communication architecture for many consumer devices. Instead of providing a different radio interface for every use case, device vendors could rely solely on 5G as the link for wide-area, local-area and personal-area communications.

### SUMMARY

According to a first aspect of the present disclosure, a method at a first UE for communicating with a second UE via a first relay UE is provided. The method comprises: negotiating, with the first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

According to a second aspect of the present disclosure, a UE is provided. The UE comprises: a processor; a memory storing instructions which, when executed by the processor, cause the processor to perform any of the methods of the first aspect.

According to a third aspect of the present disclosure, a UE is provided. The UE comprises: a negotiating module configured to negotiate, with the first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link. In some embodiments, the UE comprises one or more further modules configured to perform any of the methods of the first aspect.

According to a fourth aspect of the present disclosure, a method at a first relay UE for facilitating communication between a first UE and a second UE is provided. The method comprises: negotiating, with the first UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

According to a fifth aspect of the present disclosure, a UE is provided. The UE comprises: a processor; a memory storing instructions which, when executed by the processor, cause the processor to perform any of the methods of the fourth aspect.

According to a sixth aspect of the present disclosure, a UE is provided. The UE comprises: a negotiating module configured to negotiate, with the first UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link. In some embodiments, the UE comprises one or more further modules configured to perform any of the methods of the fourth aspect.

According to a seventh aspect of the present disclosure, a method at a network node for facilitating a first UE in communicating with a second UE via a first relay UE is provided. The method comprises: negotiating, with the first relay UE via the first UE or with the first UE via the first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

According to an eighth aspect of the present disclosure, a network node is provided. The network node comprises: a processor; a memory storing instructions which, when executed by the processor, cause the processor to perform any of the methods of the seventh aspect.

According to a ninth aspect of the present disclosure, a network node is provided. The network node comprises: a negotiating module configured to negotiate, with the first relay UE via the first UE or with the first UE via the first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link. In some embodiments, the network node comprises one or more further modules configured to perform any of the methods of the seventh aspect.

According to a tenth aspect of the present disclosure, a computer program comprising instructions is provided. The instructions, when executed by at least one processor, cause the at least one processor to carry out the method of any of the first, fourth, and seventh aspects.

According to an eleventh aspect of the present disclosure, a carrier containing the computer program of the tenth aspect is provided. In some embodiments, the carrier is one of an electronic signal, optical signal, radio signal, or computer readable storage medium.

According to a twelfth aspect of the present disclosure, a telecommunications network is provided. The telecommunications network comprises: one or more UEs of the second and/or third aspects; one or more UEs of the fifth and/or sixth aspects. In some embodiments, the telecommunications network further comprises one or more network nodes of the eighth and/or ninth aspects.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary network in which QoS configuration and management for U2U relay based communication may be applicable according to an embodiment of the present disclosure.

FIG. 2A and FIG. 2B are diagrams illustrating exemplary protocol stacks for layer 2 (L2) UE-to-UE relay in which QoS configuration and management for U2U relay based communication may be applicable according to an embodiment of the present disclosure.

FIG. 3 is a diagram illustrating an exemplary protocol stack for layer 3 (L3) UE-to-UE relay in which QoS configuration and management for U2U relay based communication may be applicable according to an embodiment of the present disclosure.

FIG. 4 is a diagram illustrating an exemplary procedure for QoS control for L3 U2U relay according to an embodiment of the present disclosure.

FIG. 5 is a diagram illustrating an exemplary procedure for QoS control for L2 U2U relay according to an embodiment of the present disclosure.

FIG. 6 is a flow chart of an exemplary method at a first UE for communicating with a second UE via a first relay UE according to an embodiment of the present disclosure.

FIG. 7 is a flow chart of an exemplary method at a first relay UE for facilitating communication between a first UE and a second UE according to an embodiment of the present disclosure.

FIG. 8 is a flow chart of an exemplary method at a network node for facilitating a first UE in communicating with a second UE via a first relay UE according to an embodiment of the present disclosure.

FIG. 9 schematically shows an embodiment of an arrangement which may be used in a UE and/or a network node according to an embodiment of the present disclosure.

FIG. 10 is a block diagram illustrating an exemplary UE according to an embodiment of the present disclosure.

FIG. 11 is a block diagram illustrating another exemplary UE according to another embodiment of the present disclosure.

FIG. 12 is a block diagram illustrating an exemplary network node according to an embodiment of the present disclosure.

FIG. 13 schematically illustrates a telecommunication network connected via an intermediate network to a host computer according to an embodiment of the present disclosure.

FIG. 14 is a generalized block diagram of a host computer communicating via a base station with a user equipment over a partially wireless connection according to an embodiment of the present disclosure.

FIG. 15 to FIG. 18 are flowcharts illustrating methods implemented in a communication system including a host computer, a base station, and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5^{th} Generation New Radio (5G NR), the present disclosure is not limited thereto. In fact, as long as QoS configuration and management for U2U relay based communication is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division—Synchronous CDMA (TD-SCDMA), CDMA2000, Worldwide Interoperability for Microwave Access (WiMAX), Wireless Fidelity (Wi-Fi), Long Term Evolution (LTE), etc. Therefore, one skilled in the arts could readily understand that the terms used herein may also refer to their equivalents in any other infrastructure. For example, the term “User Equipment” or “UE” used herein may refer to a mobile device, a mobile terminal, a mobile station, a user device, a user terminal, a wireless device, a wireless terminal, an IoT device, a vehicle, or any other equivalents. For another example, the term “gNB” used herein may refer to a base station, a base transceiver station, an access point, a hot spot, a NodeB (NB), an evolved NodeB (eNB), a network element, a network node, an access network (AN) node, or any other equivalents. Further, the term “node” used herein may refer to a UE, a functional entity, a network entity, a network element, a network equipment, or any other equivalents. Further, please note that the terms “destination UE”, “destination remote UE”, “target UE”, and “target remote UE” may be used interchangeably herein after.

Further, following 3GPP documents are incorporated herein by reference in their entireties:
3GPP TR 23.752 V2.0.0 (2021-03), Technical Report, 3rd Generation Partnership Project; Technical Specification Group Services and System Aspects; Study on system enhancement for Proximity based Services (ProSe) in the 5G System (5GS) (Release 17);
3GPP TS 36.300 V16.7.0 (2021-12), Technical Specification, 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 16);
3GPP TS 36.331 V16.7.0 (2021-12), Technical Specification, 3rd Generation Partnership Project; Technical Specification Group Radio Access Network; Evolved Universal Terrestrial Radio Access (E-UTRA); Radio Resource Control (RRC); Protocol specification (Release 16);
3GPP TS 38.300 V16.8.0 (2021-12), Technical Specification, 3rd Generation Partnership Project; Technical Specification Group Radio Access Network; NR; NR and NG-RAN Overall Description; Stage 2 (Release 16);
3GPP TS 38.331 V16.7.0 (2021-12), Technical Specification, 3rd Generation Partnership Project; Technical Specification Group Radio Access Network; NR; Radio Resource Control (RRC) protocol specification (Release 16); and
3GPP TR 38.836 V17.0.0 (2021-03), Technical Report, 3rd Generation Partnership Project; Technical Specification Group Radio Access Network; Study on NR sidelink relay; (Release 17).

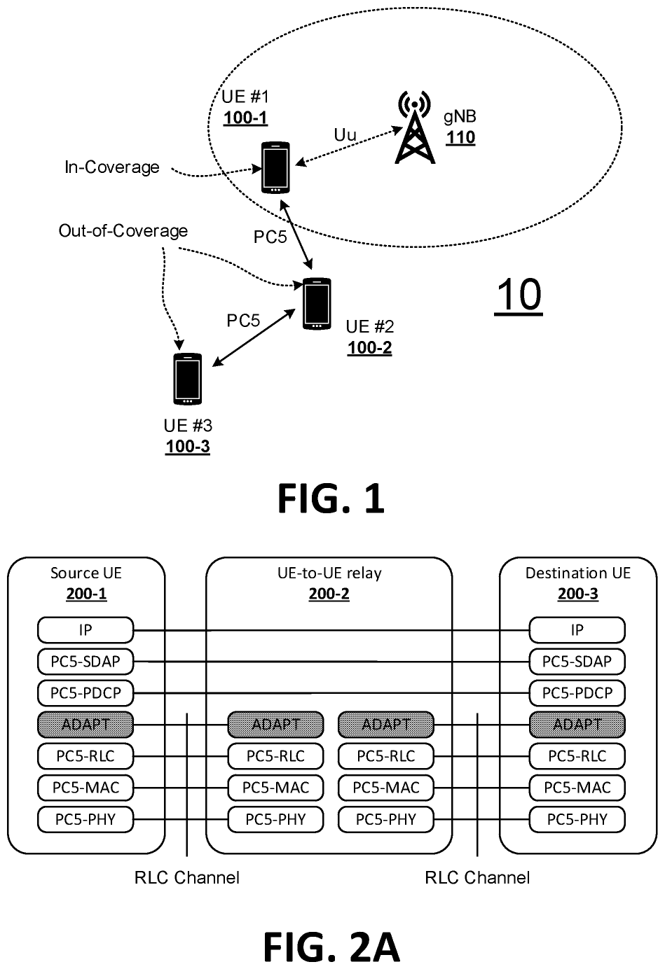

FIG. 1 is a diagram illustrating an exemplary network 10 in which QoS configuration and management for U2U relay based communication may be applicable according to an embodiment of the present disclosure. Although the network 10 is a network defined in the context of 5G NR, the present disclosure is not limited thereto.

As shown in FIG. 1, the network 10 may comprise one or more UEs 100-1, 100-2, and 100-3 (collectively, UE(s) 100) and optionally a Radio Access Network (RAN) node 110, which could be a base station, a Node B, an evolved NodeB (eNB), a gNB, or an Access Network (AN) node which provides the UEs 100 with access to the network 10. Further, the network 10 may comprise other nodes and/or entities that are not shown in FIG. 1, for example (but not limited to) an Access & Mobility Management Function (AMF), a Session Management Function (SMF), a Policy Control Function (PCF), and/or a User Plane Function (UPF). Further, as shown in FIG. 1, the UEs 100 may communicate with each other via sidelinks over the reference point PC5, and the UE 100-1 may communicate with the gNB 110 over the reference point Uu.

However, the present disclosure is not limited thereto. In some other embodiments, the network 10 may comprise additional network functions, less network functions, or some variants of the existing network functions shown in FIG. 1. For example, in a network with the 4G architecture, the entities which perform these functions may be different from those shown in FIG. 1. For another example, in a network with a mixed 4G/5G architecture, some of the entities may be same as those shown in FIG. 1, and others may be different. Further, the functions shown in FIG. 1 are not essential to the embodiments of the present disclosure. In other words, some of them may be missing from some embodiments of the present disclosure. For example, in some embodiments, there is no gNB 110 or there are one or more gNBs that serve some or all of the UEs 100, respectively.

3GPP specified the LTE D2D (device-to-device) technology, also known as sidelink (SL) or the PC5 interface as part of Release 12 (Rel-12). The targeted use case (UC) was Proximity Services (communication and discovery) and was enhanced during Rel-13. In Rel-14, LTE sidelink was extensively redesigned to support vehicular communications (commonly referred to as Vehicle-to-Everything (V2X) or Vehicle-to-Vehicle (V2V)), which was again enhanced during Rel-15. From the point of view of the lowest radio layers, LTE SL supports only broadcast communications i.e., transmission from a UE using LTE SL targets any receiver that is in range.

ProSe (Proximity Services) was introduced in LTE Rel-12 and 13. Later in Rel-14 and 15, LTE V2X related enhancements targeting the specific characteristics of vehicular communications were specified. However, in LTE V2X, only broadcast is supported over sidelink.

In Rel-16, 3GPP introduced sidelink for the 5G new radio (NR) i.e., NR SL. The use-cases were vehicular communications with more stringent requirements than those typically set in the LTE SL. Therefore, to meet these requirements, the following new enhancements were introduced to NR sidelink transmissions as follows:
Support for unicast and groupcast transmissions are added in NR sidelink. For unicast and groupcast, the physical sidelink feedback channel (PSFCH) is introduced for a receiver UE to reply with the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of Physical Sidelink Control Channel (PSCCH).
To achieve a high connection density, congestion control and thus the QoS management is supported in NR sidelink transmissions.

In groupcast communications, the intended receivers of a message are typically a subset of the vehicles near the transmitter, whereas in unicast communication, there is only a single intended receiver. Both the LTE SL and the NR SL can operate with and without network coverage and with varying degrees of interaction between the UEs (user equipment) and the NW (network), including support for standalone, network-less operation.

In Rel-17, 3GPP worked on enhancements to the NR SL. The ambition was not only to improve the capabilities of NR SL for V2X but also to address other use-cases such as National Security and Public Safety (NSPS) as well as commercial UCs such as Network Controlled Interactive Services (NCIS). To address such new use-cases, the Rel-17 work item included the aspect of UE-to-Network (U2N) relaying over the sidelink i.e., a relay UE, which is capable of sidelink communications and is within coverage of a network (e.g., the UE 100-1 shown in FIG. 1), can relay transmissions to that network from another UE (e.g., the UE 100-2 shown in FIG. 1), which is also capable of sidelink communications and is within/outside the coverage of the network. This would enable UE(s) with poor coverage or out-of-coverage of a network to reach the network for essential services.

In Rel-18, the concept of relaying is further enhanced, and another aspect known as UE-to-UE (U2U) relaying over sidelink is included in the work item. The concept of U2U relaying is that a relay UE (e.g., the UE 100-2 shown in FIG. 1) can relay transmissions to a destination UE (e.g., the UE 100-3 shown in FIG. 1) from a source UE (e.g., the UE 100-1 shown in FIG. 1) because the source/destination UE(s) are not within vicinity of each other. This is an essential aspect to improve coverage extension in the sidelink especially for use-cases related to public safety. In addition, the U2U relaying will be specified in the standards to include both Layer-2 based U2U relays and Layer-3 based U2U relays. U2U relay has been studied in Rel-17 (more details are described below) but did not proceed to normative phase.

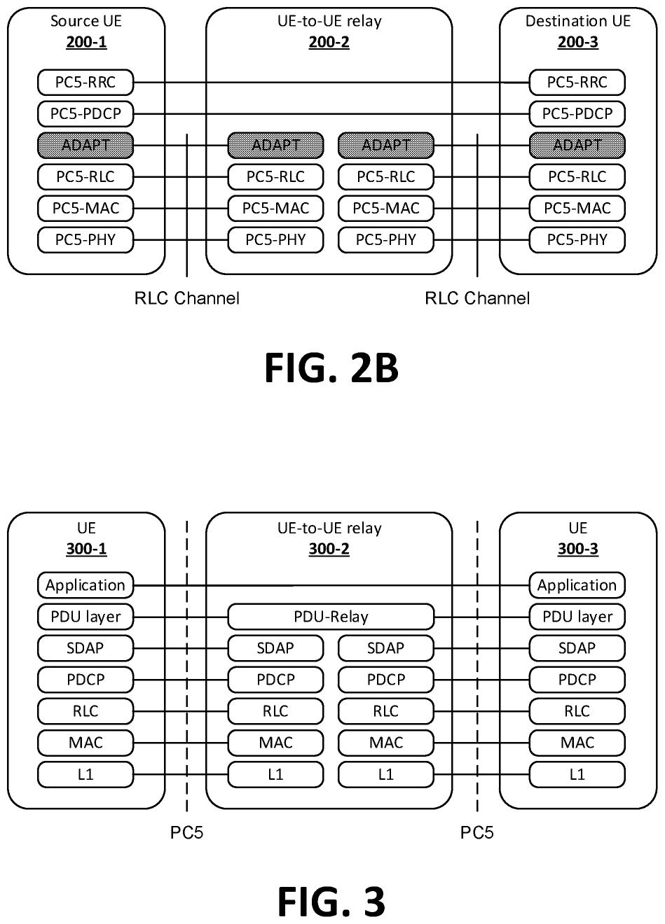

FIG. 2A and FIG. 2B are diagrams illustrating exemplary User Plane (UP) and Control Plane (CP) protocol stacks for layer 2 (L2) UE-to-UE relay in which QoS configuration and management for U2U relay based communication may be applicable according to an embodiment of the present disclosure.

For L2 UE-to-UE Relay architecture, the protocol stacks are similar to L2 UE-to-Network (U2N) Relay other than the fact that the termination points are two Remote UEs (i.e., the source UE 200-1 and the destination UE 200-3). As shown in FIG. 2A and FIG. 2B, an adaptation layer (shown as “ADAPT”) is supported over the second PC5 link (i.e. the PC5 link between the relay UE 200-2 and the destination UE 200-3) for L2 UE-to-UE Relay. For L2 UE-to-UE Relay, the adaptation layer is put over Radio Link Control (RLC) sublayer for both CP and UP over the second PC5 link. The sidelink Service Data Adaptation Protocol (SDAP)/Packet Data Convergence Protocol (PDCP) and RRC are terminated between two Remote UEs, while RLC, Medium Access Control (MAC) and physical (PHY) are terminated in each PC5 link.

For the first hop of L2 UE-to-UE Relay:
The N:1 mapping is supported by first hop PC5 adaptation layer between Remote UE SL Radio Bearers and first hop PC5 RLC channels for relaying.
The adaptation layer over first PC5 hop between Source Remote UE 200-1 and Relay UE 200-2 supports to identify traffic destined to different Destination Remote UEs 200-3.

For the second hop of L2 UE-to-UE Relay:
The second hop PC5 adaptation layer can be used to support bearer mapping between the ingress RLC channels over first PC5 hop and egress RLC channels over second PC5 hop at Relay UE 200-2.
PC5 Adaptation layer supports the N:1 bearer mapping between multiple ingress PC5 RLC channels over first PC5 hop and one egress PC5 RLC channel over second PC5 hop and supports the Remote UE identification function.

FIG. 3 is a diagram illustrating an exemplary protocol stack for layer 3 (L3) UE-to-UE relay in which QoS configuration and management for U2U relay based communication may be applicable according to an embodiment of the present disclosure.

As shown in FIG. 3, the L3 UE-to-UE relay UE 300-2 may relay unicast traffic between two UEs (so called source UE 300-1 and target UE 300-3). It shall provide generic function that can relay any IP, Ethernet, or Unstructured traffic. As shown in FIG. 3, the relaying may be performed in the Protocol Data Unit (PDU) layer. Source UE 300-1 may not be visible to the target UE 300-3 and vice versa. The two endpoints of the PC5 PDCP link are the source/target UE 300-1/300-3 and the relay UE 300-2, which means Sidelink Radio Bearer (SLRB) and PC5-RRC are per hop, i.e., there is no end-to-end SLRB, PC5-RRC and Access Stratum (AS) layer security.

When a source UE (e.g., the UE 100-1 shown in FIG. 1, the UE 200-1 shown in FIG. 2A and FIG. 2B, or the UE 300-1 shown in FIG. 3) wants to communicate with a target UE (e.g., the UE 100-3 shown in FIG. 1, the UE 200-3 shown in FIG. 2A and FIG. 2B, or the UE 300-3 shown in FIG. 3), the source UE will decide the end to end (E2E) QoS parameters between source UE and target UE based on the application layer requirements. When they communicate via a Relay UE (e.g., the UE 100-2 shown in FIG. 1, the UE 200-2 shown in FIG. 2A and FIG. 2B, or the UE 300-2 shown in FIG. 3), the E2E QoS parameters, especially the Packet Delay Budget (PDB), needs to be split between the two PC5 interface. The Packet Error Rate (PER) of the two PC5 interfaces also needs to be set properly to achieve the PER target in the E2E QoS parameters. One way to implement this is that the Relay UE splits the E2E QoS parameters into two parts: one part is the QoS parameters used by the source UE for transmission towards the Relay UE (i.e., “source side PC5 QoS parameters”), the other part is the QoS parameters used by the Relay UE for transmission towards the target UE (i.e., “Target side PC5 QoS parameters”). The Relay UE ensures that the QoS parameters in the Source side PC5 QoS parameters and Target side PC5 QoS parameters are compatible and the E2E QoS requirements are met.

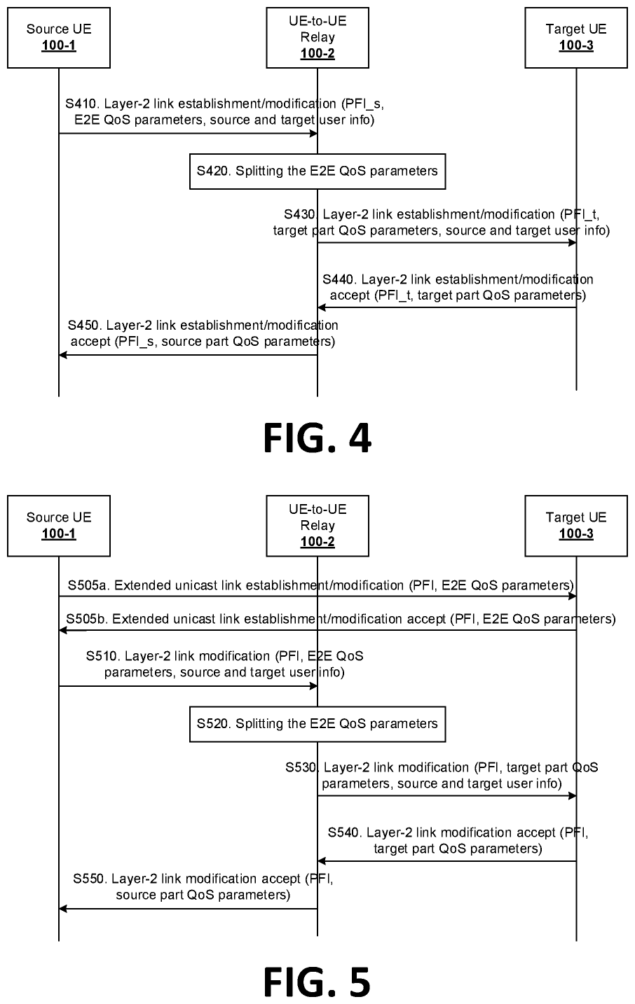

FIG. 4 is a diagram illustrating an exemplary procedure for QoS control for L3 U2U relay according to an embodiment of the present disclosure. As shown in FIG. 4, a source UE (e.g., the UE 100-1 shown in FIG. 1 or the UE 300-1 shown in FIG. 3) tries to communicate with a target UE (e.g., the UE 100-3 shown in FIG. 1 or the UE 300-3 shown in FIG. 3) via an L3 U2U relay UE (e.g., the UE 100-2 shown in FIG. 1 or the UE 300-2 shown in FIG. 3). However, the present disclosure is not limited thereto. For example, in some other embodiments, more than one U2U relay UE may be involved in the procedure, and for each of the U2U relay UEs involved, similar steps may be performed.

At step S410, the Source UE 100-1 may want to establish unicast communication with the target UE 100-3, and it may decide the E2E QoS parameters between the source UE 100-1 and the target UE 100-3 based on the application layer requirements. The Source UE 100-1 may set up a PC5 QoS Flow with PC5 QoS Flow Identifier, PFI=PFI_s. Then the Source UE 100-1 may provide the PFI_s, E2E QoS parameters, source and target user info to the UE-to-UE Relay 100-2. The process may be similar to the unicast L2 link establishment or modification procedure as defined in TS 23.287 clause 6.3.3.

At step S420, the Relay 100-2 may split the E2E QoS parameters into two parts: one part is for the PC5 interface between source UE 100-1 and Relay 100-2, the other part is for the PC5 interface between Relay 100-2 and the target UE 100-3. Relay 100-2 may setup a PC5 QoS Flow with PFI=PFI_t using the target side PC5 QoS parameters between Relay 100-2 and the target UE 100-3.

At step S430, Relay 100-2 may provide the PFI_t, target side PC5 QoS parameters, source and target user info to target UE 100-3. The process is similar to the unicast L2 link establishment or modification procedure as defined in TS 23.287 clause 6.3.3.

At step S440, Relay 100-2 may receive the Layer-2 link establishment/modification accept from target UE 100-3.

At step S450, Relay 100-2 may provide the Layer-2 link establishment/modification accept to the source UE 100-1 with the PFI_s and the source side PC5 QoS parameters.

The data transfer on Layer 3 UE-to-UE Relay may be according to traffic filter on both hops.

FIG. 5 is a diagram illustrating an exemplary procedure for QoS control for L2 U2U relay according to an embodiment of the present disclosure. As shown in FIG. 5, a source UE (e.g., the UE 100-1 shown in FIG. 1 or the UE 200-1 shown in FIG. 2A and FIG. 2B) tries to communicate with a target UE (e.g., the UE 100-3 shown in FIG. 1 or the UE 200-3 shown in FIG. 2A and FIG. 2B) via an L2 U2U relay UE (e.g., the UE 100-2 shown in FIG. 1 or the UE 200-2 shown in FIG. 2A and FIG. 2B). However, the present disclosure is not limited thereto. For example, in some other embodiments, more than one U2U relay UE may be involved in the procedure, and for each of the U2U relay UEs involved, similar steps may be performed.

At steps S505a and S505b, when the Source UE 100-1 wants to communicate with the target UE 100-3, it may use the extended unicast link defined in solution #9 in 3GPP TR 23.752, and the Source UE 100-1 may decide the E2E QoS parameters between Source UE 100-1 and Target UE 100-3 based on the application layer requirements. The Source UE 100-1 may set up a PC5 QoS Flow with PFI, similar to the V2X mechanism defined in clause 6.3.3.1 of TS 23.287, the Source UE 100-1 may negotiate the information about PC5 QoS Flow, which includes the PFI, the corresponding E2E PC5 QoS parameters and the associated application info, with the Target UE 100-3 in step S505a and step S505b. In this step, E2E PC5-S messages may be used for E2E QoS negotiation, and the UE-to-UE Relay 100-2 may just transfer the E2E PC5-S messages using the RAN specified L2 relay method.

NOTE: The PC5-S messages used in steps S505a and S505b may be the E2E PC5-S messages transferred between the Source UE 100-1 and the Target UE 100-3 and the PC5-S messages used in step S510 to step S550 may be the per-hop PC5-S messages transferred between the Source UE 100-1 or the Target UE 100-3 and the UE-to-UE Relay 100-2.

At step S510, after the E2E QoS parameter negotiation in step S505a and step S505b, the Source UE 100-1 may provide the PFI, E2E QoS parameters, source and target user info to UE-to-UE Relay 100-2. The process is similar to the unicast L2 link establishment or modification procedure as defined in TS 23.287 clause 6.3.3.

At step S520, Relay 100-2 may split the E2E QoS parameters into two parts: one part is for the PC5 interface between source UE 100-1 and Relay 100-2 (source side PC5 QoS parameters), the other part is for the PC5 interface between Relay 100-2 and the target UE 100-3 (target side PC5 QoS parameters).

At step S530, Relay 100-2 may provide the PFI received from source UE 100-1, target side PC5 QoS parameters, source and target user info to target UE 100-3. The process is similar to the unicast L2 link establishment or modification procedure as defined in TS 23.287 clause 6.3.3.

At step S540, Relay 100-2 may receive the Layer-2 link establishment/modification accept from target UE 100-3.

At step S550, Relay 100-2 may provide the Layer-2 link establishment/modification accept to the source UE 100-1 with the PFI and the source side PC5 QoS parameters.

After the PC5 QoS parameters splitting for two PC5 links, the AS layer configurations for PC5 QoS parameters in each of the PC5 links can be achieved according to legacy mechanisms in Rel-16 V2X (TS 23.287). For the QoS enforcement, the UE-to-UE Relay UE 100-2 may perform the necessary adaptation in the AS layers of the two PC5 interfaces, and it may transfer the received data based on the adaptation in the AS layer.

If the Source UE 100-1 or Target UE 100-3 wants to add, remove or modify a QoS flow on the extended unicast link, the link modification procedure defined in clause 6.3.3.4 of TS 23.287 can be used, where the Link Modification Request message may be the E2E PC5-S message.

One objective of the Rel-18 Work Item (WI) on SL relays is to specify QoS handling mechanisms for U2U relaying. QoS control for U2U relay has been studied in Rel-17, but there are several problems with the Rel-17 solutions:
QoS parameters/configurations used by the Transmitter (TX) UE for its transmission towards the U2U relay is determined by the U2U relay (i.e., the Receiver (Rx) UE), while the parameters/configurations used for SL transmission should be decided by the TX UE rather than by another UE.
PC5 QoS flow/radio bearer (RB) is E2E with L2 relay, while in the Rel-17 QoS control solution for L2 relays assumes that the QoS flow is E2E while RB is still per hop, the U2U relay can map the TX UE's QoS flow to RB over the hop between the U2U relay and the RX UE based on PC5 flow ID (PFI) and the associated QoS parameters for that hop using procedures defined in TS 23.287. Obviously, this is not correct and cannot work for L2 U2U relay where RB is E2E and is invisible to the relay UE.

The above problems may be addressed or at least alleviated in some embodiments of the present disclosure.

In some embodiments of the present disclosure, the setting up and application of the QoS parameters/configurations may be enabled in the case of U2U relaying when a TX UE is communicating with a RX UE via a U2U relay. The procedure may be based on a TX UE/U2U relay determining and negotiating the QoS parameters/configurations with a U2U relay/TX UE over the sidelink PC5 interface with/without the assistance of the NW (e.g., RAN and/or core network (CN)). The negotiations may be made for both the first link (TX UE to U2U relay) and second link (U2U relay to RX UE) including a split of certain QoS parameters like the packet delay budget (PDB)/packet error rate (PER). These parameters which can be split across the two links are grouped together as a part of the so-called “split QoS configuration”. It is possible that more than one set of QoS parameters/configurations or split QoS configurations can exist. In addition, the negotiation of the QoS parameters/configurations (including the split QoS configurations) can take place before, during, or after the establishment of the link between the TX UE/U2U relay/RX UE. When performed before the link establishment, the QoS parameters/configurations or the split QoS configurations can be included in the first PC5 message (PC5-S signaling, for example, the discovery message) from the TX UE/U2U relay. In addition, some embodiments of the present disclosure may also enable methods to setup the QoS parameters/configurations (including the split QoS configuration) for the second link based on the procedures on the first link.

Therefore, application of QoS parameters/configurations for a single/multi-hop scenario may be achieved. With some embodiments of the present disclosure, the Tx UE and the relay UE can determine QoS parameters/configurations to use for the transmission and relaying of the Tx UE's traffic. Some embodiments of the present disclosure may be applied to both L2 relay and L3 relay. Some embodiments of the present disclosure may ensure a proper QoS handling for both L2 relay and L3 relay.

Please note that some embodiments herein are described in the context of NR, i.e., two or more SL UEs are deployed in a same or different NR cell. However, the same principle may be also applied to LTE or any other technology that enables the direct connection of two (or more) nearby devices. Some embodiments are also applicable to relay scenarios of UE-to-UE relays where the remote UE and the relay UE may be based on LTE sidelink or NR sidelink, the Uu connection between the relay UE and the base station may be LTE Uu or NR Uu.

Some embodiments are applicable to L2 and L3 based U2U relay scenarios. In addition, it may be assumed that the TX UE and RX UE are U2U relay capable and can be under any form of coverage scenario, i.e., Tx UE (i.e., source UE), Rx UE (i.e., target UE) and relay UE may be either within or out of NW coverage.

Some embodiments are not restricted by any term defined in the above texts. Any other similar term is inter-changeably applicable here without any loss of the meaning. In addition, some embodiments, though applicable to L2 and L3 relays separately, are written in a generic form without a reference to either of the relaying solutions i.e., L2/L3.

In some embodiments of the present disclosure, overall procedures to setup the QoS requirements/Logical Channel (LCH) configurations are described. These procedures and corresponding embodiments are written in form of a TX UE communicating with a RX UE via a U2U relay i.e., over a single hop. However, the present disclosure is not limited thereto, and the procedures/embodiments are equally applicable to the case when the TX UE and RX UE communicate over multiple hops.

In some embodiments, the Tx UE may negotiate with the U2U relay on what QoS parameters/configurations should be used for transmission of the TX UE's service/application over the QoS flows/Radio Bearers (RBs) in the first link (i.e., between the Tx UE and the U2U relay). In addition, the TX UE may also negotiate with the U2U relay on the QoS parameters/configurations for forwarding of the same service over QoS flows/RBs on the second link (i.e., between the U2U relay and the RX UE or another relay UE in a multi-hop scenario). This can be implemented in the following ways:
In some embodiments, TX UE/U2U relay may determine the QoS parameters/configurations to be used on the first/second link and inform over the sidelink interface (PC5-RRC or PC5-S) (at least) the second/first link QoS parameters/configurations to the U2U relay UE/TX UE. In some embodiments, the TX UE/U2U relay can also determine more than one set of QoS parameters/configurations to be used on the first/second hop and communicate the same with the U2U relay/TX UE.
In some embodiments, the U2U relay/TX UE may determine whether to accept/reject the second/first link QoS parameters/configurations and inform over the sidelink interface (PC5-RRC or PC5-S) its decision to the TX UE/U2U relay. In some embodiments, the decision to accept/reject the QoS parameters/configurations can be based on the UE's capabilities and the E2E QoS requirements of the service/application to be supported. For example, in terms of capabilities, the TX UE/U2U relay can check if the application of the QoS parameters/configurations would result in the total Layer-2 buffer size to exceed a threshold. In another example, in terms of E2E QoS requirements, the TX UE/U2U relay can check, considering the number of hops, if the QoS parameters/configurations satisfy the E2E requirements of the service.
In some embodiments, in the case that the set of (at least one) QoS parameters/configurations is rejected, the TX UE/U2U relay may determine a new set (at least one) of QoS parameters/configurations and repeat the procedure again. In some embodiments, the rejection can also optionally include a ‘cause’ value to indicate the reason for the rejection. In addition, the TX UE/U2U relay can also consider this cause value to determine the new set (at least one) of QoS parameters/configurations.
In some embodiments, the negotiation may be performed during or after the link establishment between the UEs, for example, the Tx UE and U2U relay. In some embodiments, if none of the QoS parameters/configurations can be agreed after a (pre)configured number of negotiations, the ongoing link establishment may be aborted and/or the established link may be released.
In some embodiments, the negotiation of the QoS parameters/configurations may only be specific to those parameters/configurations which can be split across the two links (for example, PDB, PER). In some embodiments, these parameters can be grouped into a separate configuration known as the split QoS configuration.
In some embodiments, the negotiation may be for the QoS parameters/configurations associated with certain QoS flows (e.g., in case of L3 relay) or with certain LCH configurations (e.g., in case of L2 relay) for the first hop and a corresponding QoS flow or LCH configuration in the second hop (In some embodiments, “corresponding” means the QoS flows/LCH configurations on the two links (single-hop) or next link (multi-hop) serve the same service/RB at the RX UE). In this case, the determining UE should also inform the services and/or QoS flows and/or RBs (e.g., service/QoS flow/RB IDs) associated with the determined QoS parameters/configurations to the peer UE.
In some embodiments, the negotiation may be for the first hop and the second hop QoS parameters/configurations that are associated with certain E2E QoS parameters/configurations (e.g., PDB, PER) of a RB. In this case, the determining UE should also inform the E2E QoS parameters/configurations associated with the determined per hop QoS parameters/configurations to the peer UE.
In some embodiments, the negotiation may be on how to setup the split QoS configurations between the two links. In this case, the determining UE may inform the split QoS configuration to the peer UE. The split QoS configuration may be common or different for all services/QoS flows/RBs. In addition, more than one split configuration can be determined for the same services/QoS flows/RBs.
In some embodiments, the U2U Relay UE/TX UE may provide some assistance info to the TX UE/U2U relay, for example, the supported/preferred QoS parameters/configurations (including supported/preferred split QoS configurations) in the second/the first link. In addition, the E2E QoS parameters/configurations can be provided (for example, when the U2U relay determines the QoS parameters/configurations with assistance from the Tx UE). In some embodiments, the assistance info may be associated with services/QoS flows/RBs, i.e., it can be specific to services and/or QoS flows and/or RBs. In some embodiments, this assistance information can be signaled over the sidelink interface (PC5-RRC or PC5-S) along with the acceptance/rejection of the determined QoS parameters/configurations.
In some embodiments, if the Tx UE/U2U Relay is under full/partial coverage, the NW (gNB/CN) may determine the QoS parameters/configurations (including the split QoS configuration) to be used on the two links and signal the same to the TX UE/U2U relay over the Uu interface (via dedicated RRC signaling). In addition, the TX UE/U2U Relay may signal to the NW over the Uu interface (via RRC signaling) the received assistance info. In some embodiments, the NW can use this information for determining the QoS parameters/configurations (including the split QoS configuration). In some embodiments, the TX UE/U2U relay may also inform the NW about the acceptance/rejection of the determined QoS parameters/configurations (including the split configuration) based on which the NW may provide a new set of (at least one) QoS parameters/configurations (including split QoS configuration), if previously rejected.

In some embodiments, the TX UE and/or the U2U relay may signal (over PC5-S) one or more of the following QoS information before link establishment e.g., during the discovery message:
Set of QoS parameters/configurations allowed/preferred by the UE's transmission, i.e., the first link QoS parameters/configurations for the TX UE and the second link QoS parameters/configurations for the U2U relay.
Set of allowed/preferred split QoS configurations e.g., PDB, PER.
The services and/or QoS flows and/or RBs associated to the above QoS info.
The E2E QoS parameters/configurations (e.g., PDB, PER) associated to the above QoS info.

In some embodiments, when the relay UE receives such info from a Tx UE, it could determine whether it can configure the second hop QoS parameters/configurations with which the E2E QoS parameters/configurations required by the Tx UE can be met. If not, it may not respond to the message sent by the Tx UE, or it indicates in the response message whether it can meet the E2E QoS parameters/configurations required by the Tx UE. In some embodiments, if the Tx UE does not receive the response from the relay UE within a (pre)configured period or the response indicates that the relay UE cannot meet the E2E QoS parameters/configurations required by the Tx UE, the Tx UE may deprioritize selection of this relay UE.

In some embodiments, when the Tx UE receives such info from a relay UE, it could determine whether it can configure the first hop QoS parameters/configurations with which the E2E QoS parameters/configurations it requires can be met. If not, the Tx UE may deprioritize selection of this relay UE.

In some embodiments, the first hop/second hop QoS parameters/configurations and/or the QoS split allowed/preferred by the Tx UE/Relay UE may be preconfigured in the UE, hard coded in the spec, provided by the NW when the UE is in coverage, or up to the UE's implementation.

In some embodiments, upon completion of the necessary check for the QoS parameters/configurations (including the split QoS configuration) received from the U2U relay, a TX UE may select a U2U relay (among many) and initiate the PC5 link establishment for communicating with the RX UE via the U2U relay.

In some embodiments, when the U2U relay is an L3 relay, the TX UE may indicate in a sidelink PC5-S message (for example, PC5 link establishment), along with an acceptance, which of the QoS parameters/configurations (including split QoS configuration) was chosen to be associated to the QoS flow of the first link. Based on this information, the U2U relay may determine the second link QoS parameters/configurations associated to the QoS flow of the second link.

In some embodiments, when the U2U relay is an L2 relay, the TX UE may indicate in a sidelink PC5-RRC message (e.g., RRCReconfigurationSidelink), along with an acceptance, which of the QoS parameters/configurations (including split QoS configuration) was chosen to be associated to a LCH in the first link. Based on this information, the U2U relay may determine the second hop QoS parameters/configurations (including split QoS configuration) associated to a LCH on the second link.

In some embodiments, for the QoS parameters/configurations that need not to be split between the two hops (e.g., priority, data rate, etc.), the U2U relay may determine those QoS parameters/configurations to be used in any of the following ways. In addition, at the U2U relays, the mapping between the two configurations may be performed to enable forwarding of the data from the TX UE to the RX UE.
Duplication
   Duplication of QoS parameters/configurations to be used in the first hop, i.e., apply the same QoS parameters/configurations used in the first hop to the second hop. This is more suitable when 1:1 mapping is applied.
   In a multi-hop scenario, each U2U relay on the path between the TX UE and RX UE can perform duplication of the QoS parameters/configurations.
Based on QoS parameters/configurations to be used in the first hop and the QoS flow mapping (in case of e.g., L3 relay) or LCH mapping (in case of e.g. L2 relay). For instance, if multiple first hop QoS flows/LCHs mapped to the same second hop QoS flow/LCH, the second hop QoS parameters/configurations such as data rate of the second hop QoS flow/LCH may be set as the aggregated data rate of all the first hop QoS flows/LCHs mapped to the second hop QoS flow/LCH. In case one first hop LCH mapped to multiple second hop LCHs (this may happen for L2 relay when one Tx UE transmits to multiple Rx UE via the relay UE), the second hop data rate for each of the second hop LCH may be set as a portion of the data rate of the first hop LCH where the portion is set based on the data rate of RBs served by the first hop LCH and the data rate of RBs served by each of the second hop LCHs. This may require the Tx UE to indicate the data rate associated to the RBs to the relay UE.

In some embodiments, depending on the coverage scenario of the TX/RX UE(s)/U2U relays, the NW can provide the mapping between the QoS parameters/configurations of the first and second link in the form of mapping restrictions. These restrictions can include, for example, the allowed mapping between the priority values i.e., a restriction can allow for a mapping between only high priority values or only low priority values or between high/low priority values. The mapping restrictions are not limited to the aspect of priority but can also include other aspects not mentioned in this embodiment. These mapping restrictions can also be obtained from the NW when within coverage and used when operating in out-of-coverage. Further, these restrictions can also be preconfigured in the TX UE(s)/RX UE(s)/U2U relays.

In some embodiments, for any of the above embodiments, the signaling alternatives described may include at least one of the below.

In some embodiments, for signaling between UE and the gNB:
RRC signaling
MAC CE (Control Element)
Paging message
Control PDU of a protocol layer (e.g., SDAP, PDCP, RLC, or an adaptation layer in case of SL relay)
L1 signaling on channels such as Physical Random Access Channel (PRACH), Physical Uplink Control Channel (PUCCH), Physical Downlink Control Channel (PDCCH).

In some embodiments, for signaling between UEs:
RRC signaling (e.g., PC5-RRC)
PC5-S signaling
Discovery signaling
MAC CE
Control PDU of a protocol layer (e.g., SDAP, PDCP, RLC, or an adaptation layer in case of SL relay)
L1 signaling on channels such as Physical Sidelink Shared Channel (PSSCH), PSCCH, or PSFCH.

With the embodiments described above, a mechanism for configuring and managing QoS parameters for U2U relay based communication is provided, such that a TX UE/U2U relay may determine and negotiate the QoS parameters/configurations with a U2U relay/TX UE over the sidelink PC5 interface with/without the assistance of the NW. The negotiations may be made for both the first link (TX UE to U2U relay) and second link (U2U relay to RX UE) including a split of certain QoS parameters.

Further, with the embodiments described above, it is possible that more than one set of QoS parameters/configurations or split QoS configurations can exist. In addition, the negotiation of the QoS parameters/configurations (including the split QoS configurations) can take place before, during, or after the establishment of the link between the TX UE/U2U relay/RX UE. When performed before the link establishment, the QoS parameters/configurations or the split QoS configurations can be included in the first PC5 message (PC5-S signaling, for example, the discovery message) from the TX UE/U2U relay. In addition, some embodiments of the present disclosure may also enable methods to setup the QoS parameters/configurations (including the split QoS configuration) for the second link based on the procedures on the first link.

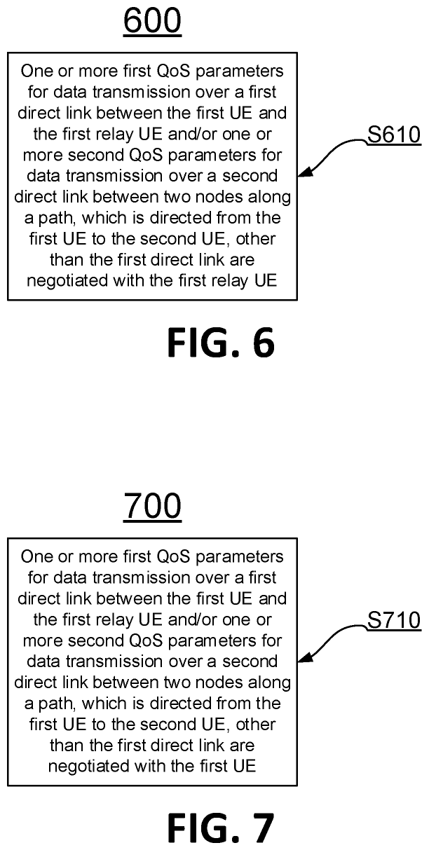

FIG. 6 is a flow chart of an exemplary method 600 at a first UE for communicating with a second UE via a first relay UE according to an embodiment of the present disclosure. The method 600 may be performed at a UE (e.g., the UE 100-1) for QoS configuration and management. The method 600 may comprise a step S610. However, the present disclosure is not limited thereto. In some other embodiments, the method 600 may comprise more steps, different steps, or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610 where one or more first QoS parameters for data transmission over a first direct link between the first UE and the first relay UE and/or one or more second QoS parameters for data transmission over a second direct link between two nodes along a path, which is directed from the first UE to the second UE, other than the first direct link may be negotiated with the first relay UE.

In some embodiments, the step of negotiating one or more first QoS parameters and/or one or more second QoS parameters may comprise: determining a set of one or more first QoS parameters and/or a set of one or more second QoS parameters; and transmitting, to the first relay UE, a first message indicating the determined set of one or more first QoS parameters and/or the determined set of one or more second QoS parameters. In some embodiments, the step of negotiating one or more first QoS parameters and/or one or more second QoS parameters may comprise: determining more than one set of one or more first QoS parameters for data transmission over the first direct link and/or more than one set of one or more second QoS parameters for data transmission over the second direct link; and transmitting, to the first relay UE, a first message indicating the determined more than one set of one or more first QoS parameters and/or the determined more than one set of one or more second QoS parameters. In some embodiments, the step of negotiating one or more first QoS parameters and/or one or more second QoS parameters may comprise: receiving, from the first relay UE, a second message indicating whether the QoS parameters received by the first relay UE are accepted or rejected by the first relay UE. In some embodiments, the method 600 may further comprise: in response to the QoS parameters being rejected by the first relay UE: determining another set of one or more first QoS parameters and/or another set of one or more second QoS parameters; and transmitting, to the first relay UE, a third message indicating the determined other set of one or more first QoS parameters and/or the determined other set of one or more second QoS parameters.

In some embodiments, the step of negotiating one or more first QoS parameters and/or one or more second QoS parameters may comprise: receiving, from the first relay UE, a first message indicating a set of one or more first QoS parameters and/or a set of one or more second QoS parameters. In some embodiments, the step of negotiating one or more first QoS parameters and/or one or more second QoS parameters may comprise: receiving, from the first relay UE, a first message indicating more than one set of one or more first QoS parameters for data transmission over the first direct link and/or more than one set of one or more second QoS parameters for data transmission over the second direct link. In some embodiments, the step of negotiating one or more first QoS parameters and/or one or more second QoS parameters may comprise: determining whether the received QoS parameters can be accepted or not at least based on one or more capabilities of the first UE and/or one or more E2E QoS requirements of at least one service or application to be supported by the first UE; and transmitting, to the first relay UE, a second message indicating whether the received QoS parameters are accepted or rejected by the first UE at least based on the determination. In some embodiments, the step of determining whether the received QoS parameters can be accepted or not may comprise: determining whether the received QoS parameters are accepted or not in response to determining whether the application of the received QoS parameters would result in the total TX buffer size to exceed a threshold. In some embodiments, the step of determining whether the received QoS parameters can be accepted or not may comprise: determining whether the received QoS parameters are accepted or not in response to determining whether the received QoS parameters can satisfy the E2E requirements of the service or application. In some embodiments, when the received QoS parameters are rejected by the first UE, the method 600 may further comprise: receiving, from the first relay UE, a third message indicating another set of one or more first QoS parameters and/or another set of one or more second QoS parameters.

In some embodiments, when the second message indicates that the QoS parameters are rejected, the second message may further indicate a reason for the rejection, and the other set of one or more first QoS parameters and/or the other set of one or more second QoS parameters that are indicated by the third message are determined at least based on the reason for the rejection. In some embodiments, the step of negotiating one or more first QoS parameters and/or one or more second QoS parameters may be performed during or after the first direct link is established. In some embodiments, the method 600 may further comprise: aborting an ongoing link establishment procedure for the first direct link and/or releasing the first direct link in response to determining that none of the QoS parameters can be agreed by both of the first UE and the first relay UE after a configured number of negotiations.

In some embodiments, the one or more first QoS parameters and/or the one or more second QoS parameters may be QoS parameters that can be split across more than one link. In some embodiments, the one or more first QoS parameters and/or the one or more second QoS parameters may comprise at least one of: PDB and PER. In some embodiments, the one or more first QoS parameters may be associated with one or more QoS flows or LCHs for the first direct link. In some embodiments, the one or more second QoS parameters may be associated with one or more QoS flows or LCHs for the second direct link corresponding to the one or more QoS flows or LCHs for the first direct link. In some embodiments, the first message may further indicate at least one of: one or more identifiers of the one or more QoS flows associated with the first QoS parameters; one or more identifiers of the one or more QoS flows associated with the second QoS parameters; one or more identifiers of the one or more LCHs associated with the first QoS parameters; one or more identifiers of the one or more LCHs associated with the second QoS parameters; one or more identifiers of one or more RBs associated with the first QoS parameters; one or more identifiers of one or more RBs associated with the second QoS parameters.

In some embodiments, the one or more first QoS parameters and/or the one or more second QoS parameters may be associated with one or more E2E QoS parameters. In some embodiments, the first message may further indicate the one or more E2E QoS parameters. In some embodiments, the one or more split QoS configurations may be commonly or separately determined for all services, all QoS flows, and/or all RBs. In some embodiments, more than one split QoS configuration may be determined for a same service, a same QoS flow, and/or a same RB.

In some embodiments, the method 600 may further comprise at least one of: receiving, from the first relay UE, assistance information for determining the one or more first QoS parameters and/or the one or more second QoS parameters; and transmitting, to the first relay UE, assistance information for determining the one or more first QoS parameters and/or the one or more second QoS parameters. In some embodiments, the assistance information may comprise at least one of: one or more supported QoS parameters; one or more preferred QoS parameters; one or more supported split QoS configurations; one or more preferred split QoS configurations; and one or more E2E QoS parameters. In some embodiments, the assistance information may be associated with one or more services, one or more QoS flows, and/or one or more RBs. In some embodiments, the assistance information may be indicated by the second message. In some embodiments, the step of negotiating one or more first QoS parameters and/or one or more second QoS parameters may comprise: receiving, from a network node serving the first UE, the one or more first QoS parameters and/or the one or more second QoS parameters; and transmitting, to the first relay UE, the one or more first QoS parameters and/or the one or more second QoS parameters. In some embodiments, the method 600 may further comprise: receiving, from the first relay UE, an indication indicating whether the one or more first QoS parameters and/or the one or more second QoS parameters are accepted or rejected by the first relay UE; transmitting, to the network node, the received indication; and receiving, from the network node, another set of one or more first QoS parameters and/or another set of one or more second QoS parameters in response to the received indication indicating that the one or more first QoS parameters and/or the one or more second QoS parameters are rejected by the first relay UE. In some embodiments, before the step of receiving, from the network node, the one or more first QoS parameters and/or the one or more second QoS parameters, the method 600 may further comprise: receiving, from the first relay UE, assistance information for determining the one or more first QoS parameters and/or the one or more second QoS parameters; and transmitting, to the network node, the received assistance information.

In some embodiments, the step of negotiating one or more first QoS parameters and/or one or more second QoS parameters may comprise: receiving, from the first relay UE, the one or more first QoS parameters and/or the one or more second QoS parameters; and transmitting, to a network node serving the first UE, the one or more first QoS parameters and/or the one or more second QoS parameters. In some embodiments, the method 600 may further comprise: receiving, from the network node, an indication indicating whether the one or more first QoS parameters and/or the one or more second QoS parameters are accepted or rejected by the network node; transmitting, to the first relay UE, the received indication; and receiving, from the first relay UE, another set of one or more first QoS parameters and/or another set of one or more second QoS parameters in response to the received indication indicating that the one or more first QoS parameters and/or the one or more second QoS parameters are rejected by the network node. In some embodiments, before the step of receiving, from the first relay UE, the one or more first QoS parameters and/or the one or more second QoS parameters, the method 600 may further comprise: receiving, from the network node, assistance information for determining the one or more first QoS parameters and/or the one or more second QoS parameters; and transmitting, to the first relay UE, the received assistance information.

In some embodiments, when the step of negotiating one or more first QoS parameters and/or one or more second QoS parameters is performed before link establishment between the first UE and the first relay UE, the method 600 may further comprise at least one of: transmitting, to one or more relay UEs, QoS information comprising at least one of a set of QoS parameters allowed and/or preferred by the first UE for its transmission, a set of allowed and/or preferred split QoS configurations, one or more services, QoS flows, and/or RBs that are associated with the set of QoS parameters and/or the set of split QoS configurations, and one or more E2E QoS parameters associated with the set of QoS parameters and/or the set of split QoS configurations; and receiving, from each of one or more relay UEs, QoS information comprising at least one of a set of QoS parameters allowed and/or preferred by the corresponding relay UE for its transmission, a set of allowed and/or preferred split QoS configurations, one or more services, QoS flows, and/or RBs that are associated with the set of QoS parameters and/or the set of split QoS configurations, and one or more E2E QoS parameters associated with the set of QoS parameters and/or the set of split QoS configurations. In some embodiments, the method 600 may further comprise: deprioritizing selection of a relay UE for link establishment in response to no response being received from the corresponding relay UE within a configured time period or a response, which is received from the corresponding relay UE, indicating that the corresponding relay UE cannot meet the requirements in the QoS information. In some embodiments, for at least one of the one or more relay UEs, the method 600 may further comprise: determining whether one or more E2E QoS parameters required by the first UE can be met or not at least based on the QoS information received from the at least one relay UE; deprioritizing selection of the at least one relay UE for link establishment in response to determining that the one or more E2E QoS parameters required by the first UE cannot be met.

In some embodiments, at least one of the one or more first QoS parameters, the one or more second QoS parameters, the one or more split QoS configurations may be preconfigured at the first UE, hard coded in a technical specification, configured by a network node when the first UE is in its coverage, or up to the first UE's implementation. In some embodiments, the method 600 may further comprise: initiating a link establishment procedure for establishing a direct link to the first relay UE when the first relay UE can meet the E2E QoS requirements of the first UE. In some embodiments, the method 600 may further comprise: transmitting, to the first relay UE, a sidelink PC5-S message indicating an acceptance of the QoS information and indicating which of the QoS parameters indicated by the QoS information is chosen to be associated with a QoS flow over the first direct link. In some embodiments, the method 600 may further comprise: transmitting, to the first relay UE, a sidelink PC5-RRC message indicating an acceptance of the QoS information and indicating which of the QoS parameters indicated by the QoS information is chosen to be associated with an LCH over the first direct link. In some embodiments, the method 600 may further comprise: receiving, from a network node serving the first UE, a mapping restriction indicating a mapping between QoS parameters for the first direct link and QoS parameters for the second direct link. In some embodiments, the mapping restriction may comprise at least an allowed mapping between priority values for the first and second direct links. In some embodiments, after the mapping restriction is received from the network node, the mapping restriction can be used even when the first UE is not served by the network node. In some embodiments, a mapping restriction indicating a mapping between QoS parameters for the first direct link and QoS parameters for the second direct link may be preconfigured at the first UE.

In some embodiments, signaling between the first UE and the network node may comprise at least one of: NAS signalling; RRC signaling; MAC CE; Paging message; Control PDU of a protocol layer; and L1 signaling. In some embodiments, signaling between the first UE and the first relay UE may comprise at least one of: RRC signaling; PC5-S signaling; Discovery signaling; MAC CE; Control PDU of a protocol layer; and L1 signaling. In some embodiments, the first UE and the first relay UE may be UEs capable of sidelink communication and the first direct link is a sidelink. In some embodiments, the first relay UE may be a U2U relay UE.

FIG. 7 is a flow chart of an exemplary method 700 at a first relay UE for facilitating communication between a first UE and a second UE according to an embodiment of the present disclosure. The method 700 may be performed at a UE (e.g., the UE 100-2) for QoS configuration and management. The method 700 may comprise a step S710. However, the present disclosure is not limited thereto. In some other embodiments, the method 700 may comprise more steps, different steps, or any combination thereof. Further the steps of the method 700 may be performed in a different order than that described herein. Further, in some embodiments, a step in the method 700 may be split into multiple sub-steps and performed by different entities, and/or multiple steps in the method 700 may be combined into a single step.

The method 700 may begin at step S710 where one or more first QoS parameters for data transmission over a first direct link between the first UE and the first relay UE and/or one or more second QoS parameters for data transmission over a second direct link between two nodes along a path, which is directed from the first UE to the second UE, other than the first direct link may be negotiated with the first UE.

In some embodiments, the step of negotiating one or more first QoS parameters and/or one or more second QoS parameters may comprise: determining a set of one or more first QoS parameters and/or a set of one or more second QoS parameters; and transmitting, to the first UE, a first message indicating the determined set of one or more first QoS parameters and/or the determined set of one or more second QoS parameters. In some embodiments, the step of negotiating one or more first QoS parameters and/or one or more second QoS parameters may comprise: determining more than one set of one or more first QoS parameters for data transmission over the first direct link and/or more than one set of one or more second QoS parameters for data transmission over the second direct link; and transmitting, to the first UE, a first message indicating the determined more than one set of one or more first QoS parameters and/or the determined more than one set of one or more second QoS parameters. In some embodiments, the step of negotiating one or more first QoS parameters and/or one or more second QoS parameters may comprise: receiving, from the first UE, a second message indicating whether the QoS parameters received by the first UE are accepted or rejected by the first UE. In some embodiments, the method 700 may further comprise: in response to the QoS parameters being rejected by the first UE: determining another set of one or more first QoS parameters and/or another set of one or more second QoS parameters; and transmitting, to the first UE, a third message indicating the determined other set of one or more first QoS parameters and/or the determined other set of one or more second QoS parameters.

In some embodiments, the step of negotiating one or more first QoS parameters and/or one or more second QoS parameters may comprise: receiving, from the first UE, a first message indicating a set of one or more first QoS parameters and/or a set of one or more second QoS parameters. In some embodiments, the step of negotiating one or more first QoS parameters and/or one or more second QoS parameters may comprise: receiving, from the first UE, a first message indicating more than one set of one or more first QoS parameters for data transmission over the first direct link and/or more than one set of one or more second QoS parameters for data transmission over the second direct link. In some embodiments, the step of negotiating one or more first QoS parameters and/or one or more second QoS parameters may comprise: determining whether the received QoS parameters can be accepted or not at least based on one or more capabilities of the first relay UE and/or one or more E2E QoS requirements of at least one service or application to be supported by the first relay UE; and transmitting, to the first UE, a second message indicating whether the received QoS parameters are accepted or rejected by the first relay UE at least based on the determination. In some embodiments, the step of determining whether the received QoS parameters can be accepted or not may comprise: determining whether the received QoS parameters are accepted or not in response to determining whether the application of the received QoS parameters would result in the total TX buffer size to exceed a threshold. In some embodiments, the step of determining whether the received QoS parameters can be accepted or not may comprise: determining whether the received QoS parameters are accepted or not in response to determining whether the received QoS parameters can satisfy the E2E requirements of the service or application. In some embodiments, when the received QoS parameters are rejected by the first relay UE, the method 700 may further comprise: receiving, from the first UE, a third message indicating another set of one or more first QoS parameters and/or another set of one or more second QoS parameters.

In some embodiments, when the second message indicates that the QoS parameters are rejected, the second message may further indicate a reason for the rejection, and the other set of one or more first QoS parameters and/or the other set of one or more second QoS parameters that are indicated by the third message may be determined at least based on the reason for the rejection. In some embodiments, the step of negotiating one or more first QoS parameters and/or one or more second QoS parameters may be performed during or after the first direct link is established. In some embodiments, the method 700 may further comprise: aborting an ongoing link establishment procedure for the first direct link and/or releasing the first direct link in response to determining that none of the QoS parameters can be agreed by both of the first UE and the first relay UE after a configured number of negotiations. In some embodiments, the one or more first QoS parameters and/or the one or more second QoS parameters may be QoS parameters that can be split across more than one link.

In some embodiments, the one or more first QoS parameters and/or the one or more second QoS parameters may comprise at least one of: PDB and PER. In some embodiments, the one or more first QoS parameters may be associated with one or more QoS flows or LCHs for the first direct link. In some embodiments, the one or more second QoS parameters may be associated with one or more QoS flows or LCHs for the second direct link corresponding to the one or more QoS flows or LCHs for the first direct link. In some embodiments, the first message may further indicate at least one of: one or more identifiers of the one or more QoS flows associated with the first QoS parameters; one or more identifiers of the one or more QoS flows associated with the second QoS parameters; one or more identifiers of the one or more LCHs associated with the first QoS parameters; one or more identifiers of the one or more LCHs associated with the second QoS parameters; one or more identifiers of one or more RBs associated with the first QoS parameters; one or more identifiers of one or more RBs associated with the second QoS parameters.

In some embodiments, the one or more first QoS parameters and/or the one or more second QoS parameters may be associated with one or more E2E QoS parameters. In some embodiments, the first message may further indicate the one or more E2E QoS parameters. In some embodiments, the one or more split QoS configurations may be commonly or separately determined for all services, all QoS flows, and/or all RBs. In some embodiments, more than one split QoS configuration may be determined for a same service, a same QoS flow, and/or a same RB. In some embodiments, the method 700 may further comprise at least one of: receiving, from the first UE, assistance information for determining the one or more first QoS parameters and/or the one or more second QoS parameters; and transmitting, to the first UE, assistance information for determining the one or more first QoS parameters and/or the one or more second QoS parameters. In some embodiments, the assistance information may comprise at least one of: one or more supported QoS parameters; one or more preferred QoS parameters; one or more supported split QoS configurations; one or more preferred split QoS configurations; and one or more E2E QoS parameters. In some embodiments, the assistance information may be associated with one or more services, one or more QoS flows, and/or one or more RBs. In some embodiments, the assistance information may be indicated by the second message.

In some embodiments, the step of negotiating one or more first QoS parameters and/or one or more second QoS parameters may comprise: receiving, from a network node serving the first relay UE, the one or more first QoS parameters and/or the one or more second QoS parameters; and transmitting, to the first UE, the one or more first QoS parameters and/or the one or more second QoS parameters. In some embodiments, the method 700 may further comprise: receiving, from the first UE, an indication indicating whether the one or more first QoS parameters and/or the one or more second QoS parameters are accepted or rejected by the first UE; transmitting, to the network node, the received indication; and receiving, from the network node, another set of one or more first QoS parameters and/or another set of one or more second QoS parameters in response to the received indication indicating that the one or more first QoS parameters and/or the one or more second QoS parameters are rejected by the first UE. In some embodiments, before the step of receiving, from the network node, the one or more first QoS parameters and/or the one or more second QoS parameters, the method 700 may further comprise: receiving, from the first UE, assistance information for determining the one or more first QoS parameters and/or the one or more second QoS parameters; and transmitting, to the network node, the received assistance information.

In some embodiments, the step of negotiating one or more first QoS parameters and/or one or more second QoS parameters may comprise: receiving, from the first UE, the one or more first QoS parameters and/or the one or more second QoS parameters; and transmitting, to a network node serving the first relay UE, the one or more first QoS parameters and/or the one or more second QoS parameters. In some embodiments, the method 700 may further comprise: receiving, from the network node, an indication indicating whether the one or more first QoS parameters and/or the one or more second QoS parameters are accepted or rejected by the network node; transmitting, to the first UE, the received indication; and receiving, from the first UE, another set of one or more first QoS parameters and/or another set of one or more second QoS parameters in response to the received indication indicating that the one or more first QoS parameters and/or the one or more second QoS parameters are rejected by the network node. In some embodiments, before the step of receiving, from the first UE, the one or more first QoS parameters and/or the one or more second QoS parameters, the method 700 may further comprise: receiving, from the network node, assistance information for determining the one or more first QoS parameters and/or the one or more second QoS parameters; and transmitting, to the first UE, the received assistance information.

In some embodiments, when the step of negotiating one or more first QoS parameters and/or one or more second QoS parameters is performed before link establishment between the first UE and the first relay UE, the method 700 may further comprise at least one of: receiving, from the first UE, QoS information comprising at least one of a set of QoS parameters allowed and/or preferred by the first UE for its transmission, a set of allowed and/or preferred split QoS configurations, one or more services, QoS flows, and/or RBs that are associated with the set of QoS parameters and/or the set of split QoS configurations, and one or more E2E QoS parameters associated with the set of QoS parameters and/or the set of split QoS configurations; and transmitting, to the first UE, QoS information comprising at least one of a set of QoS parameters allowed and/or preferred by the first relay UE for its transmission, a set of allowed and/or preferred split QoS configurations, one or more services, QoS flows, and/or RBs that are associated with the set of QoS parameters and/or the set of split QoS configurations, and one or more E2E QoS parameters associated with the set of QoS parameters and/or the set of split QoS configurations. In some embodiments, when the QoS information is received from the first UE, the method 700 may further comprise: determining whether one or more second QoS parameters, with which one or more requirements in the received QoS information can be met, can be configured for data transmission over the second direct link or not; and transmitting, to the first UE, no response in response to determining that the one or more second QoS parameters cannot be configured. In some embodiments, when the QoS information is received from the first UE, the method 700 may further comprise: determining whether one or more second QoS parameters, with which one or more requirements in the received QoS information can be met, can be configured for data transmission over the second direct link or not; and transmitting, to the first UE, a response indicating whether the first relay UE cannot meet the requirements in the received QoS information at least based on the determination.

In some embodiments, at least one of the one or more first QoS parameters, the one or more second QoS parameters, the one or more split QoS configurations may be preconfigured at the first relay UE, hard coded in a technical specification, configured by a network node when the first relay UE is in its coverage, or up to the first relay UE's implementation. In some embodiments, the method 700 may further comprise: initiating a link establishment procedure for establishing a direct link to the first UE when the first relay UE can meet the E2E QoS requirements of the first UE. In some embodiments, the method 700 may further comprise: receiving, from the first UE, a sidelink PC5-S message indicating an acceptance of the QoS information and indicating which of the QoS parameters indicated by the QoS information is chosen to be associated with a QoS flow over the first direct link. In some embodiments, the method 700 may further comprise: receiving, from the first UE, a sidelink PC5-RRC message indicating an acceptance of the QoS information and indicating which of the QoS parameters indicated by the QoS information is chosen to be associated with an LCH over the first direct link.

In some embodiments, the method 700 may further comprise: determining one or more third QoS parameters, which need not to be split across more than one link, for data transmission over the first direct link; and determining one or more fourth QoS parameters, which need not to be split across more than one link and corresponding to the one or more third QoS parameters, for data transmission over the second direct link. In some embodiments, the method 700 may further comprise: mapping the one or more third QoS parameters and the one or more fourth QoS parameters to each other, such that data forwarding from the first UE to the second UE is enabled. In some embodiments, the step of determining one or more fourth QoS parameters may comprise at least one of: duplicating the one or more third QoS parameters as the one or more fourth QoS parameters; and determining the one or more fourth QoS parameters at least based on at least one of the one or more third QoS parameters, a QoS flow mapping, and an LCH mapping. In some embodiments, the step of determining the one or more fourth QoS parameters at least based on at least one of the one or more third QoS parameters, a QoS flow mapping, and an LCH mapping may comprise at least one of: determining a fourth QoS parameter associated with a QoS flow or LCH over the second direct link as a sum of corresponding third QoS parameters associated with all QoS flows or LCHs over the first direct link that are mapped to the QoS flow or LCH over the second direct link; and determining a fourth QoS parameter associated with a QoS flow or LCH over the second direct link as a portion of a corresponding third QoS parameter associated with a QoS flow or LCH over the first direct link that is mapped to the QoS flow or LCH over the second direct link, wherein the QoS flow or LCH over the first direct link is mapped to more than one QoS flow or LCH over the second direct link.

In some embodiments, the method 700 may further comprise: receiving, from a network node serving the first relay UE, a mapping restriction indicating a mapping between QoS parameters for the first direct link and QoS parameters for the second direct link. In some embodiments, the mapping restriction may comprise at least an allowed mapping between priority values for the first and second direct links. In some embodiments, after the mapping restriction is received from the network node, the mapping restriction can be used even when the first relay UE is not served by the network node. In some embodiments, a mapping restriction indicating a mapping between QoS parameters for the first direct link and QoS parameters for the second direct link may be preconfigured at the first UE.

In some embodiments, signaling between the first relay UE and the network node may comprise at least one of: NAS signalling; RRC signaling; MAC CE; Paging message; Control PDU of a protocol layer; and L1 signaling. In some embodiments, signaling between the first UE and the first relay UE may comprise at least one of: RRC signaling; PC5-S signaling; Discovery signaling; MAC CE; Control PDU of a protocol layer; and L1 signaling. In some embodiments, the first UE and the first relay UE may be UEs capable of sidelink communication and the first direct link is a sidelink. In some embodiments, the first relay UE may be a U2U relay UE.

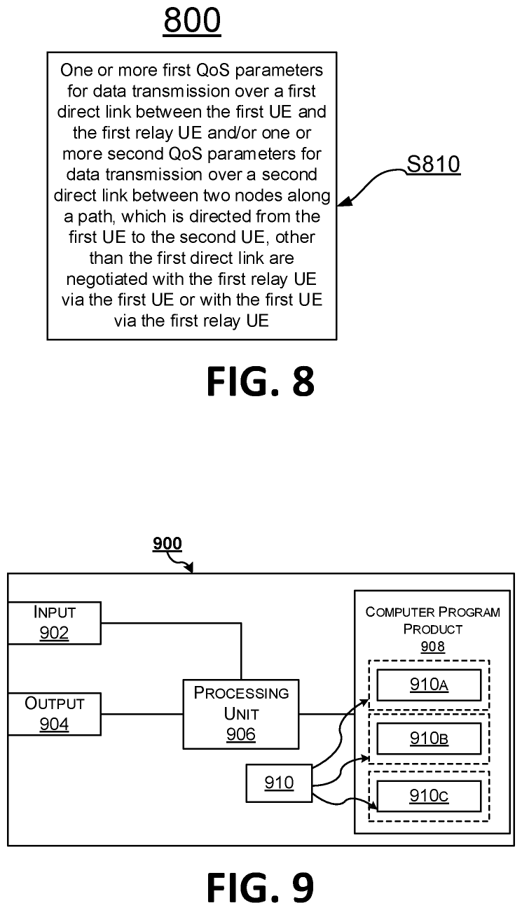

FIG. 8 is a flow chart of an exemplary method 800 at a network node for facilitating a first UE in communicating with a second UE via first relay UE according to an embodiment of the present disclosure. The method 800 may be performed at a network node (e.g., the gNB 110) for QoS configuration and management. The method 800 may comprise a step S810. However, the present disclosure is not limited thereto. In some other embodiments, the method 800 may comprise more steps, different steps, or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step.

The method 800 may begin at step S810 where one or more first QoS parameters for data transmission over a first direct link between the first UE and the first relay UE and/or one or more second QoS parameters for data transmission over a second direct link between two nodes along a path, which is directed from the first UE to the second UE, other than the first direct link may be negotiated with the first relay UE via the first UE or with the first UE via the first relay UE.

In some embodiments, the step of negotiating one or more first QoS parameters and/or one or more second QoS parameters may comprise: determining a set of one or more first QoS parameters and/or a set of one or more second QoS parameters; and transmitting, to the first relay UE via the first UE or to the first UE via the first relay UE, a first message indicating the determined set of one or more first QoS parameters and/or the determined set of one or more second QoS parameters. In some embodiments, the step of negotiating one or more first QoS parameters and/or one or more second QoS parameters may comprise: determining more than one set of one or more first QoS parameters for data transmission over the first direct link and/or more than one set of one or more second QoS parameters for data transmission over the second direct link; and transmitting, to the first relay UE via the first UE or to the first UE via the first relay UE, a first message indicating the determined more than one set of one or more first QoS parameters and/or the determined more than one set of one or more second QoS parameters. In some embodiments, the step of negotiating one or more first QoS parameters and/or one or more second QoS parameters may comprise: receiving, from the first relay UE via the first UE or from the first UE via the first relay UE, a second message indicating whether the QoS parameters received by the first relay UE or the first UE are accepted or rejected by the first relay UE or the first UE. In some embodiments, the method 800 may further comprise: in response to the QoS parameters being rejected by the first relay UE or the first UE: determining another set of one or more first QoS parameters and/or another set of one or more second QoS parameters; and transmitting, to the first relay UE via the first UE or to the first UE via the first relay UE, a third message indicating the determined other set of one or more first QoS parameters and/or the determined other set of one or more second QoS parameters. In some embodiments, the step of negotiating one or more first QoS parameters and/or one or more second QoS parameters may comprise: receiving, from the first relay UE via the first UE or from the first UE via the first relay UE, a first message indicating a set of one or more first QoS parameters and/or a set of one or more second QoS parameters.

In some embodiments, the step of negotiating one or more first QoS parameters and/or one or more second QoS parameters may comprise: receiving, from the first relay UE via the first UE or from the first UE via the first relay UE, a first message indicating more than one set of one or more first QoS parameters for data transmission over the first direct link and/or more than one set of one or more second QoS parameters for data transmission over the second direct link. In some embodiments, the step of negotiating one or more first QoS parameters and/or one or more second QoS parameters may comprise: determining whether the received QoS parameters can be accepted or not at least based on one or more capabilities of the first UE or the first relay UE and/or one or more E2E QoS requirements of at least one service or application to be supported by the first UE or the first relay UE; and transmitting, to the first relay UE via the first UE or to the first UE via the first relay UE, a second message indicating whether the received QoS parameters are accepted or rejected by the first UE or the first relay UE at least based on the determination.

In some embodiments, the step of determining whether the received QoS parameters can be accepted or not may comprise: determining whether the received QoS parameters are accepted or not in response to determining whether the application of the received QoS parameters would result in the total TX buffer size to exceed a threshold. In some embodiments, the step of determining whether the received QoS parameters can be accepted or not may comprise: determining whether the received QoS parameters are accepted or not in response to determining whether the received QoS parameters can satisfy the E2E requirements of the service or application. In some embodiments, when the received QoS parameters are rejected, the method 800 may further comprise: receiving, from the first relay UE via the first UE or from the first UE via the first relay UE, a third message indicating another set of one or more first QoS parameters and/or another set of one or more second QoS parameters.

In some embodiments, when the second message indicates that the QoS parameters are rejected, the second message may further indicate a reason for the rejection, and the other set of one or more first QoS parameters and/or the other set of one or more second QoS parameters that are indicated by the third message may be determined at least based on the reason for the rejection. In some embodiments, the step of negotiating one or more first QoS parameters and/or one or more second QoS parameters may be performed during or after the first direct link is established. In some embodiments, the method 800 may further comprise: aborting an ongoing link establishment procedure for the first direct link and/or releasing the first direct link in response to determining that none of the QoS parameters can be agreed by both of the first UE and the first relay UE after a configured number of negotiations.

In some embodiments, the one or more first QoS parameters and/or the one or more second QoS parameters may be QoS parameters that can be split across more than one link. In some embodiments, the one or more first QoS parameters and/or the one or more second QoS parameters may comprise at least one of: PDB and PER. In some embodiments, the one or more first QoS parameters may be associated with one or more QoS flows or LCHs for the first direct link. In some embodiments, the one or more second QoS parameters may be associated with one or more QoS flows or LCHs for the second direct link corresponding to the one or more QoS flows or LCHs for the first direct link. In some embodiments, the first message may further indicate at least one of: one or more identifiers of the one or more QoS flows associated with the first QoS parameters; one or more identifiers of the one or more QoS flows associated with the second QoS parameters; one or more identifiers of the one or more LCHs associated with the first QoS parameters; one or more identifiers of the one or more LCHs associated with the second QoS parameters; one or more identifiers of one or more RBs associated with the first QoS parameters; one or more identifiers of one or more RBs associated with the second QoS parameters.

In some embodiments, the one or more first QoS parameters and/or the one or more second QoS parameters may be associated with one or more E2E QoS parameters. In some embodiments, the first message may further indicate the one or more E2E QoS parameters. In some embodiments, the one or more split QoS configurations may be commonly or separately determined for all services, all QoS flows, and/or all RBs. In some embodiments, more than one split QoS configuration may be determined for a same service, a same QoS flow, and/or a same RB.

In some embodiments, the method 800 may further comprise at least one of: receiving, from the first relay UE via the first UE or from the first UE via the first relay UE, assistance information for determining the one or more first QoS parameters and/or the one or more second QoS parameters; and transmitting, to the first relay UE via the first UE or to the first UE via the first relay UE, assistance information for determining the one or more first QoS parameters and/or the one or more second QoS parameters. In some embodiments, the assistance information may comprise at least one of: one or more supported QoS parameters; one or more preferred QoS parameters; one or more supported split QoS configurations; one or more preferred split QoS configurations; and one or more E2E QoS parameters. In some embodiments, the assistance information may be associated with one or more services, one or more QoS flows, and/or one or more RBs. In some embodiments, the assistance information may be indicated by the second message.

In some embodiments, when the step of negotiating one or more first QoS parameters and/or one or more second QoS parameters is performed before link establishment between the first UE and the first relay UE, the method 800 may further comprise at least one of: transmitting, to one or more relay UEs via the first UE, QoS information comprising at least one of a set of QoS parameters allowed and/or preferred by the first UE for its transmission, a set of allowed and/or preferred split QoS configurations, one or more services, QoS flows, and/or RBs that are associated with the set of QoS parameters and/or the set of split QoS configurations, and one or more E2E QoS parameters associated with the set of QoS parameters and/or the set of split QoS configurations; and receiving, from each of one or more relay UEs via the first UE, QoS information comprising at least one of a set of QoS parameters allowed and/or preferred by the corresponding relay UE for its transmission, a set of allowed and/or preferred split QoS configurations, one or more services, QoS flows, and/or RBs that are associated with the set of QoS parameters and/or the set of split QoS configurations, and one or more E2E QoS parameters associated with the set of QoS parameters and/or the set of split QoS configurations. In some embodiments, the method 800 may further comprise: deprioritizing selection of a relay UE for link establishment in response to no response being received from the corresponding relay UE within a configured time period or a response, which is received from the corresponding relay UE, indicating that the corresponding relay UE cannot meet the requirements in the QoS information. In some embodiments, for at least one of the one or more relay UEs, the method 800 may further comprise: determining whether one or more E2E QoS parameters required by the first UE can be met or not at least based on the QoS information received from the at least one relay UE; deprioritizing selection of the at least one relay UE for link establishment in response to determining that the one or more E2E QoS parameters required by the first UE cannot be met.

In some embodiments, at least one of the one or more first QoS parameters, the one or more second QoS parameters, the one or more split QoS configurations may be preconfigured at the first UE, hard coded in a technical specification, configured by the network node when the first UE is in its coverage, or up to the first UE's implementation. In some embodiments, the method 800 may further comprise: initiating a link establishment procedure for establishing a direct link to the first relay UE or the first UE when the first relay UE can meet the E2E QoS requirements of the first UE. In some embodiments, the method 800 may further comprise: transmitting, to the first relay UE via the first UE or to the first UE via the first relay UE, a sidelink PC5-S message indicating an acceptance of the QoS information and indicating which of the QoS parameters indicated by the QoS information is chosen to be associated with a QoS flow over the first direct link. In some embodiments, the method 800 may further comprise: transmitting, to the first relay UE via the first UE or to the first UE via the first relay UE, a sidelink PC5-RRC message indicating an acceptance of the QoS information and indicating which of the QoS parameters indicated by the QoS information is chosen to be associated with an LCH over the first direct link. In some embodiments, the method 800 may further comprise: transmitting, to the first UE or the first relay UE, a mapping restriction indicating a mapping between QoS parameters for the first direct link and QoS parameters for the second direct link. In some embodiments, the mapping restriction may comprise at least an allowed mapping between priority values for the first and second direct links.

In some embodiments, signaling between the first UE or the first relay UE and the network node may comprise at least one of: NAS signalling; RRC signaling; MAC CE; Paging message; Control PDU of a protocol layer; and L1 signaling. In some embodiments, the first UE and the first relay UE may be UEs capable of sidelink communication and the first direct link is a sidelink. In some embodiments, the first relay UE may be a U2U relay UE.

FIG. 9 schematically shows an embodiment of an arrangement which may be used in a UE and/or a network node according to an embodiment of the present disclosure. Comprised in the arrangement 900 are a processing unit 906, e.g., with a Digital Signal Processor (DSP) or a Central Processing Unit (CPU). The processing unit 906 may be a single unit or a plurality of units to perform different actions of procedures described herein. The arrangement 900 may also comprise an input unit 902 for receiving signals from other entities, and an output unit 904 for providing signal(s) to other entities. The input unit 902 and the output unit 904 may be arranged as an integrated entity or as separate entities.

Furthermore, the arrangement 900 may comprise at least one computer program product 908 in the form of a non-volatile or volatile memory, e.g., an Electrically Erasable Programmable Read-Only Memory (EEPROM), a flash memory and/or a hard drive. The computer program product 908 comprises a computer program 910, which comprises code/computer readable instructions, which when executed by the processing unit 906 in the arrangement 900 causes the arrangement 900 and/or the UE and/or the network node in which it is comprised to perform the actions, e.g., of the procedure described earlier in conjunction with FIG. 6 through FIG. 8 or any other variant.

The computer program 910 may be configured as a computer program code structured in a computer program module 910A. Hence, in an exemplifying embodiment when the arrangement 900 is used in a first (remote) UE, the code in the computer program of the arrangement 900 includes: a module 910A configured to negotiate, with a first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

Additionally or alternatively, the computer program 910 may be configured as a computer program code structured in a computer program module 910B. Hence, in an exemplifying embodiment when the arrangement 900 is used in a first relay UE, the code in the computer program of the arrangement 900 includes: a module 910B configured to negotiate, with a first UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

Additionally or alternatively, the computer program 910 may be configured as a computer program code structured in a computer program module 910C. Hence, in an exemplifying embodiment when the arrangement 900 is used in a network node, the code in the computer program of the arrangement 900 includes: a module 910C configured to negotiate, with a first relay UE via a first UE or with the first UE via the first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

The computer program modules could essentially perform the actions of the flow illustrated in FIG. 6 through FIG. 8, to emulate the UE and/or the network node. In other words, when the different computer program modules are executed in the processing unit 906, they may correspond to different modules in the UE and/or the network node.

Although the code means in the embodiments disclosed above in conjunction with FIG. 9 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

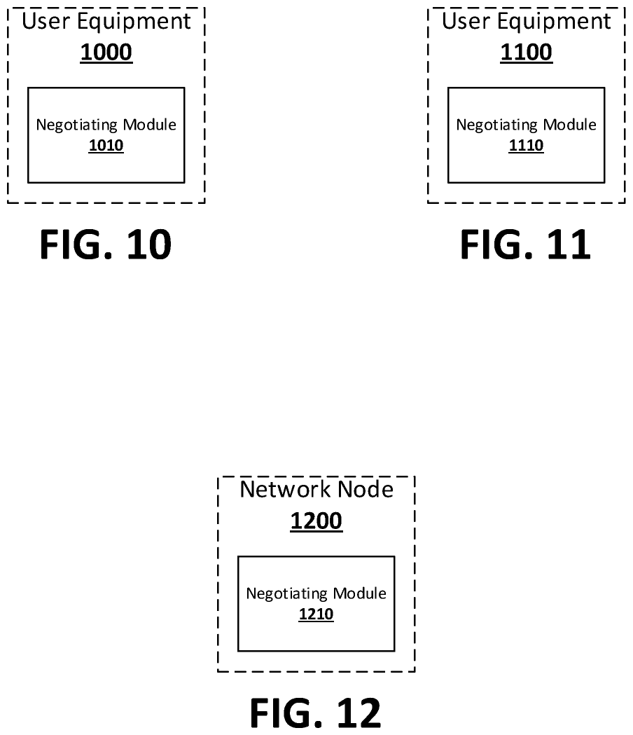

Correspondingly to the method 600 as described above, an exemplary UE is provided. FIG. 10 is a block diagram of an exemplary UE 1000 according to an embodiment of the present disclosure. The UE 1000 may be, e.g., the UE 100-1 in some embodiments.

The UE 1000 may be configured to perform the method 600 as described above in connection with FIG. 6. As shown in FIG. 10, the UE 1000 may comprise a negotiating module 1010 configured to negotiate, with a first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

The above module 1010 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6. Further, the UE 1000 may comprise one or more further modules, each of which may perform any of the steps of the method 600 described with reference to FIG. 6.

Correspondingly to the method 700 as described above, an exemplary UE is provided. FIG. 11 is a block diagram of an exemplary relay UE 1100 according to an embodiment of the present disclosure. The relay UE 1100 may be, e.g., the UE 110-2 in some embodiments.

The UE 1100 may be configured to perform the method 700 as described above in connection with FIG. 7. As shown in FIG. 11, the UE or first relay UE 1100 may comprise a negotiating module 1110 configured to negotiate, with a first UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

The above module 1110 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the UE 1100 may comprise one or more further modules, each of which may perform any of the steps of the method 700 described with reference to FIG. 7.

Correspondingly to the method 800 as described above, an exemplary network node is provided. FIG. 12 is a block diagram of an exemplary network node 1200 according to an embodiment of the present disclosure. The network node 1200 may be, e.g., the gNB 110 in some embodiments.

The network node 1200 may be configured to perform the method 800 as described above in connection with FIG. 8. As shown in FIG. 12, the network node 1200 may comprise a negotiating module 1210 configured to negotiate, with a first relay UE via a first UE or with the first UE via the first relay UE, one or more first QoS parameters for data transmission over a first direct link between the first UE and the first relay UE and/or one or more second QoS parameters for data transmission over a second direct link between two nodes along a path, which is directed from the first UE to the second UE, other than the first direct link.

The above module 1210 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 8. Further, the network node 1200 may comprise one or more further modules, each of which may perform any of the steps of the method 800 described with reference to FIG. 8.

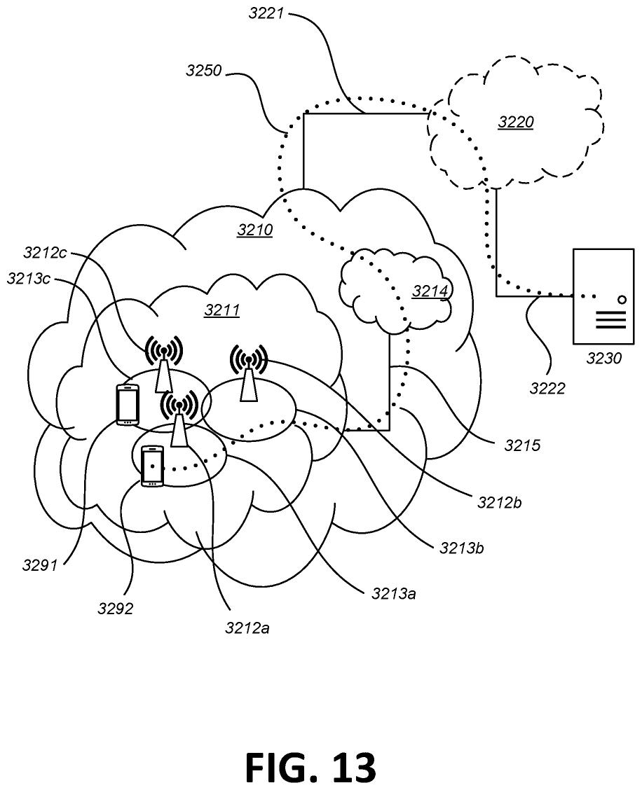

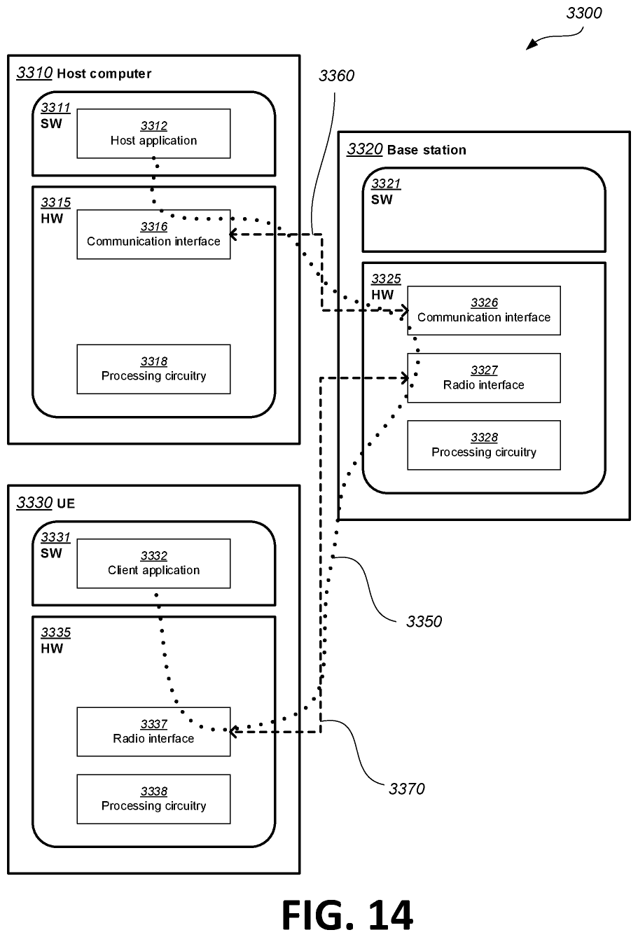

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private, or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

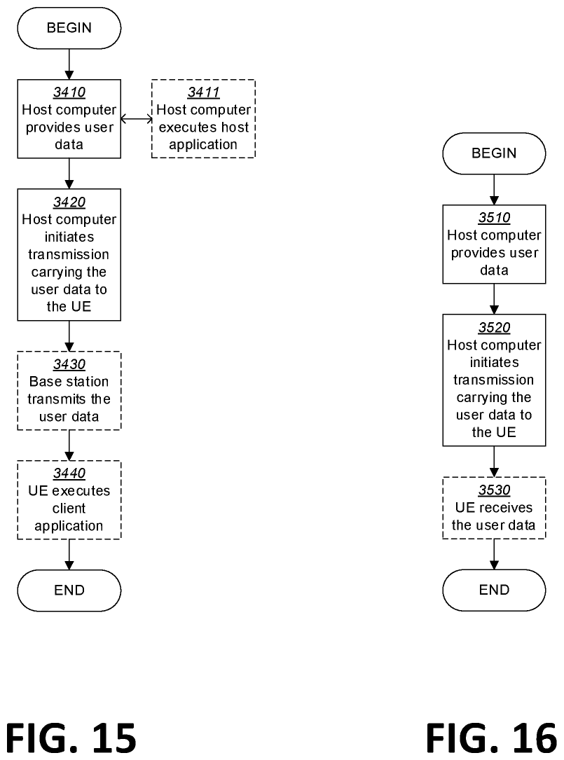

FIG. 15 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

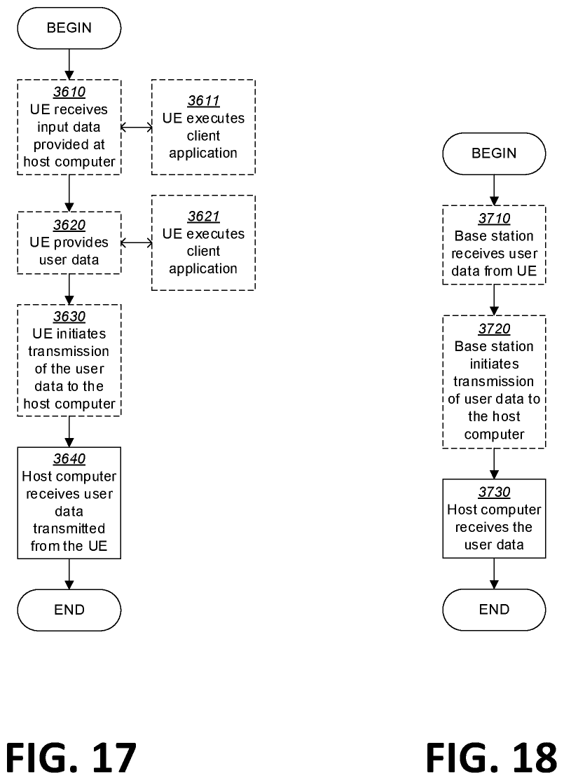

FIG. 17 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 17 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| LCH | Logical Channel |
| PDB | Packet Delay Budget |
| PER | Packet Error Rate |
| QoS | Quality of Service |
| U2U | UE-to-UE |

1.-80. (canceled)

81. A method at a first relay user equipment (UE) for facilitating communication between a first UE and a second UE, the method comprising:
receiving, from the first UE, a first message indicating one or more end-to-end (E2E) quality of service (QoS) parameters between the first UE and the second UE; and
splitting, based on the first message, the E2E QoS parameters into one or more first QoS parameters for data transmission over a first direct link between the first UE and the first relay UE and one or more second QoS parameters for data transmission over a second link between the first relay UE and the second UE.

82. The method of claim 81, wherein the one or more E2E QoS parameters comprise Packet Delay Budget (PDB), and wherein both the one or more first QoS parameters and the one or more second QoS parameters comprise a first PDB for data transmission over the first direct link and a second PDB for data transmission over the second link.

83. The method of claim 81, wherein the second link is a direct link between the first relay UE and the second UE.

84. The method of claim 81, wherein the second link comprises a direct link between the first relay UE and a second relay UE, and another link between the second relay UE and the second UE in a multi-hop scenario.

85. The method of claim 81, further comprising sending the split one or more first QoS parameters to the first UE via a PC5 interface.

86. The method of claim 81, wherein the one or more first QoS parameters are associated with one or more QoS flows or Logical Channels (LCHs) for the first direct link.

87. A user equipment (UE) configured to operate as a first relay UE for facilitating communication between a first UE and a second UE, comprising:
a processor; and
a memory storing instructions which, when executed by the processor, cause the processor to:
receive, from the first UE, a first message indicating one or more end-to-end (E2E) quality of service (QoS) parameters between the first UE and the second UE; and
split, based on the first message, the E2E QoS parameters into one or more first QoS parameters for data transmission over a first direct link between the first UE and the first relay UE and one or more second QoS parameters for data transmission over a second link between the first relay UE and the second UE.

88. The UE of claim 87, wherein the one or more E2E QoS parameters comprise Packet Delay Budget (PDB), and wherein both the one or more first QoS parameters and the one or more second QoS parameters comprise a first PDB for data transmission over the first direct link and a second PDB for data transmission over the second link.

89. The UE of claim 87, wherein the second link is a direct link between the first relay UE and the second UE.

90. The UE of claim 87, wherein the second link comprises a direct link between the first relay UE and a second relay UE, and another link between the second relay UE and the second UE in a multi-hop scenario.

91. The UE of claim 87, the memory storing instructions which, when executed by the processor, further cause the processor to send the split one or more first QoS parameters to the first UE via a PC5 interface.

92. The UE of claim 87, wherein the one or more first QoS parameters are associated with one or more QoS flows or Logical Channels (LCHs) for the first direct link.

93. A method at a first user equipment (UE) for facilitation communication with a second UE via a first relay UE, the method comprising:
sending, to the first relay UE, a first message indicating one or more end-to-end (E2E) quality of service (QoS) parameters between the first UE and the second UE; and
receiving, from the first relay UE, one or more first QoS parameters for data transmission over a first direct link between the first UE and the first relay UE, wherein the one or more first QoS parameters are split by the first relay UE from the one or more E2E QoS parameters indicated by the first message.

94. The method of claim 93, the one or more E2E QoS parameters comprise Packet Delay Budget (PDB), and wherein the one or more first QoS parameters comprise a first PDB.

95. The method of claim 93, wherein the one or more first QoS parameters are associated with one or more QoS flows or Logical Channels (LCHs) for the first direct link.

96. The method of claim 93, wherein the first UE is a relay UE along a path between a previous hop UE and the second UE, and wherein the method further comprises:
receiving, prior to sending the first message, a message indicating one or more E2E QoS parameters between the previous hop UE and the second UE; and
splitting into the one or more E2E QoS parameters indicated in the first message and one or more E2E QoS parameters for data transmission over a direct link between the previous hop UE and the first UE.

97. A first user equipment (UE) capable of communicating with a second UE via a first relay UE, the UE comprising:
a processor; and
a memory storing instructions which, when executed by the processor, cause the processor to:
send, to the first relay UE, a first message indicating one or more end-to-end (E2E) quality of service (QoS) parameters between the first UE and the second UE; and
receive, from the first relay UE, one or more first QoS parameters for data transmission over a first direct link between the first UE and the first relay UE, wherein the one or more first QoS parameters are split by the first relay UE from the one or more E2E QoS parameters indicated by the first message.

98. The first UE of claim 97, the one or more E2E QoS parameters comprise Packet Delay Budget (PDB), and wherein the one or more first QoS parameters comprise a first PDB.

99. The first UE of claim 97, wherein the one or more first QoS parameters are associated with one or more QoS flows or Logical Channels (LCHs) for the first direct link.

100. The first UE of claim 97, wherein the first UE is a relay UE along a path between a previous hop UE and the second UE, and wherein the memory stores instructions which, when executed by the processor, further cause the processor to:
receive, prior to sending the first message, a message indicating one or more E2E QoS parameters between the previous hop UE and the second UE; and
split into the one or more E2E QoS parameters indicated in the first message and one or more E2E QoS parameters for data transmission over a direct link between the previous hop UE and the first UE.
